(19) United States
(12) Patent Application Publication
(10) Pub. No.: US 2024/0113280 A1
(43) Pub. Date: Apr. 4, 2024

(54) Monolithic Electrode Assemblies With Contained Three-Dimensional Channels Usable With Ion Exchange Materials

(71) Applicant: Zelos Energy Ltd., San Leandro, CA (US)

(72) Inventors: Alexander Gorer, Brisbane, CA (US); Jonathan Truskier, Oakland, CA (US)

(21) Appl. No.: 18/480,312

(22) Filed: Oct. 3, 2023

Related U.S. Application Data
(60) Provisional application No. 63/413,086, filed on Oct. 4, 2022.

(51) Int. Cl. H01M 4/24; H01M 10/04; H01M 10/26

(52) U.S. Cl. CPC H01M 4/244; H01M 10/049; H01M 10/26; H01M 2004/021

(57) ABSTRACT

A rechargeable battery cell can include an electrode having a plurality of three-dimensional channels defined therethrough, with at least 90% of three dimensional channels sized to have pores between 50 nanometers to 400 microns. An ion exchange material can be arranged to define an interface with at least a portion of the electrode. In some embodiments the electrode includes a zinc (Zn) containing anode and a cathode including at least one of nickel hydroxide (Ni(OH)2), nickel oxyhydroxide (NiOOH), manganese dioxide (MnO2), copper oxide, and bismuth oxide.

### RELATED APPLICATIONS

This application claims the benefit of U.S. Provisional Application Ser. No. 63/413,086 filed Oct. 4, 2022, which is hereby incorporated herein by reference in its entirety for all purposes.

### TECHNICAL FIELD

The present disclosure relates generally to the field of batteries and components for batteries. More specifically, the present application relates to batteries or cells that include an ion exchange material and electrodes having contained three-dimensional channels.

### BACKGROUND

There is a great demand for low cost rechargeable battery systems with a high energy density for portable devices, electric vehicles, grid storage and other applications. Recently lithium ion batteries have become a popular technology of choice for many energy storage applications. Unfortunately, limited availability of key metals, high energy costs and safety risks associated with Li-ion technology limit wide adoption of the batteries in many application.

As an alternative, Zn-based batteries with aqueous electrolytes have been used. The lower cost and relative safety of such batteries allow them to be used in many potential applications.

### SUMMARY

In one embodiment, a rechargeable battery cell includes an electrode having incorporated three-dimensional channels and formed from zinc containing materials. Additionally, an ion exchange material is arranged to define an interface in contact with at least a portion of the electrode. Providing an interface can include completely or partially embedding the electrode in the ion exchange material, or alternatively, surrounding the electrode or discrete portions of the electrode with a thin film of ion exchange material. In one embodiment, an electrode can be a highly porous, monolithic, and sponge-like structure with the pore sizes ranging from 50 nm to 400 microns. The electrode can be coated with or arranged to partially contact ion exchange material.

In some embodiments the ion exchange material can include either an anion exchange material or a cation exchange material. The ion exchange material can include a polymeric material having attached charged functional groups.

In some embodiments, ion transport can be enable by a liquid alkaline electrolyte contacting the electrodes. Optionally, the electrolyte can have at least some incorporated ion exchange material.

In one embodiment, the rechargeable battery cell can include an electrode contacting or including embedded ion exchange material.

In one embodiment, a method of manufacturing a rechargeable battery cell can include fusing a plurality of particles into a monolithic electrode having a plurality of three dimensional channels defined therethrough, with at least 90% of three dimensional channels sized to have pores between 50 nanometers to 400 microns. In some embodiments, manufacture can involve contacting the monolithic electrode with an ion exchange material and contacting the monolithic electrode with a liquid electrolyte that can pulled by capillary force into three dimensional channels defined therethrough.

In some embodiments, manufacture can involve assembling the monolithic electrode with a liquid phase polymer membrane solution that can pulled by capillary force into three dimensional channels defined therethrough. After drying the deposited polymer layer will become an ion exchange membrane coating of the sponge electrode.

In some embodiments the current collector of the sponge electrode can include but is not limited to at least one of a metallic conductive mesh, wire or foil which is set inside the body of the electrode before high temperature fusing.

### BRIEF DESCRIPTION OF THE DRAWINGS

Non-limiting and non-exhaustive embodiments of the present disclosure are described with reference to the following FIGURES, wherein like reference numerals refer to like parts throughout the various FIGURES unless otherwise specified.

FIG. 1 illustrates a battery containing ion exchange material in contact with electrode material.

### DETAILED DESCRIPTION

The present disclosure relates in part to battery cells having improved cycle life and electrical performance in service. For example, the cells can exhibit higher battery discharge voltage, higher discharge capacity, lower internal resistance, and high-rate discharge capability. In some embodiments, the disclosed battery cells have a long cycle lifetime at high-rate discharge current.

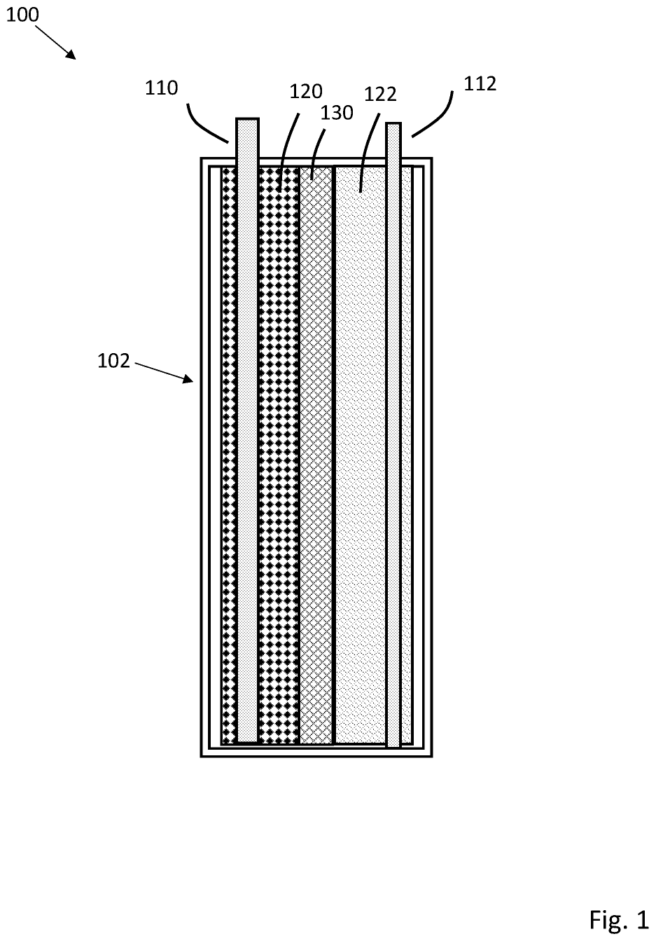

FIG. 1 illustrates a rechargeable battery cell system 100 that includes a casing 102 that surrounds various battery components. Battery components can include current collectors 110 and 112 that facilitate charge and discharge of the battery cell system 100. Other components include electrode material 120 and 122 that respectively contact current collectors 110 and 112. The current collectors 110 and 112 can be fully (as shown) or partially embedded in electrode material 120 or 122. In some embodiments, the current collectors can be attached to one or more surfaces of either or both the electrode material 120 or 122.

In one embodiment, the electrode material can include multiple interconnected three-dimensional channels that form a highly porous, monolithic, and sponge-like structure with the pore sizes ranging from 50 nm to 400 microns. Alternatively, or in addition, the electrodes can be manufactures as metal foam, a three dimensional lattice network, have inner voids connected to external pores, or include either “tangled” or disordered channel structures. In some embodiments, three-dimensional channels can have a regular or ordered layout. Advantageously, in some embodiments a combination of fully metallic sponge network, with embedded current collector and a large number of interconnected three-dimensional channels or voids provides an ideal electronic environment for improved functionalities of the electrode. This includes improved current distribution, mitigation of dendrite formation, and electrolyte access. Additionally, in some embodiments the combination of a conductive network of Zn, a current collector and three-dimensional channels or voids with the pore sizes ranging from 50 nm to 200 microns results in a very strong capillary action. Long term soaking or use of a vacuum system to draw electrolyte and/or ionic liquid material into the three-dimensional channels is not necessary, with liquid electrolyte being drawn inside the electrode due to the capillary forces.

The electrode material 120 and 122 can be separated from each other by a separator 130 that only permits ion flow between the material. The rechargeable battery cell system 100 can include anode, cathode, ion exchange, and other materials and components as described in the following:

Electrodes

Electrode material can include solid continuous pore structures, including but limited to multiple interconnected three-dimensional channels in electrode material that form a highly porous, rigid and monolithic, and/or sponge-like structure. In some embodiments, all or part of an electrode can also be formed as thin films, or structured patterns such as columns, needles, groove, or slots. In some embodiments electrodes can be loosely arranged materials, rigidly bound or sintered structures. In one embodiment, electrodes can be formed from particles provided in various forms such as powders, granules, pellets, or nanomaterial. In certain embodiments, particles can have an average size (diameter or longest dimension) of between about 0.1 μm to 300 μm, and in a specific embodiment, between about 1 μm and 100 μm. In some embodiments, relatively homogeneous particle sizes can be used, while in other embodiments heterogenous sized materials can be used. Particles can be processed to increase effective surface area. In some embodiments, particles can be processed by heating, melting, fusing, or sintering to bind together the particles. In other embodiments, additional binders can be used to hold particles together.

Collectors

At least a portion of electrode material can be embedded or placed in contact with a current collector. The current collector serves to supply an electric current so that it can be consumed for the electrode reaction during charge and collect an electric current generated during discharge. The current collector is typically formed from a material which has a high electrical conductivity and is inactive to electrochemical battery cell reaction. The current collector may be shaped in a plate form, foil form, mesh form, porous form-like sponge, punched or slotted metal form, or expanded metal form.

The material of the current collector can include Ni, Ti, Cu, Al, Pt, V, Au, Zn, and alloys of two or more of these metals such as stainless steel. Other embodiments can graphite cloth, copper sheet or mesh slotted woven brass.

Anode Material

Anode materials for an electrode can include a wide range of materials such as zinc, aluminum, magnesium, iron, and lithium and other metals in pure oxide form or salt form, or combinations thereof. In some embodiments, relatively pure Zn, ZnO or a mixture of Zn and ZnO can be used. For a rechargeable zinc negative electrode, the electrochemically active material can be manufactured from zinc oxide powder or a mixture of zinc and zinc oxide powder. The zinc oxide can dissolve in an alkaline electrolyte to form the zincate (Zn(OH)₄²⁻). Zinc oxide or/and zincate is reduced to zinc metal during the charging process.

More broadly, anode materials can include:

Any metal M, metal oxide MOx or metal salt having a redox potential EO lower than the redox potential of the cathode material.

Any metal oxide MOx having a standard potential EO lower than the redox potential of the cathode material.

Any alloy of any metals MM1M2 . . . Mn, mixed oxides or mixed salts having a EO lower than the EO of the cathode material.

Any polymer that can accommodate anions in its structure having a redox potential EO lower than the redox potential of the cathode material.

Any mixture of one or more of the above mentioned type of materials.

Cathode Material

Cathode material for an electrode can include a wide range of materials such as metal or metal containing compounds such as Fe⁶⁺, Mn⁷⁺, nickel hydroxide Ni(OH)₂, nickel oxyhydroxide NiOOH, manganese dioxide MnO₂, copper oxide, bismuth oxide, or any combinations.

More broadly, cathode materials can include:

Any metal M having a redox potential EO larger than the redox potential of the anode material.

Any metal oxide MOx having a redox potential EO larger than the redox potential of the anode material.

Any alloy of any metals MM1M2 . . . Mn having a EO larger than the EO of the anode material.

Any metal fluoride MFn having a redox potential larger than the anode material.

Any alloy MM1M2 . . . MnOxFm with n larger or equal to 2 and m being larger or equal to zero.

Any polymer that can accommodate anions in its structure having a redox potential EO larger than the redox potential of the anode material.

CFx carbon fluoride with x being between zero and 2.

Unstable salts not stable in aqueous electrolyte solutions, including but not limited to FeVI (iron six) based battery systems.

Any mixture of one or more of the above mentioned type of materials.

Additives and Binding Agents

Various additives can be used to improve electrochemical, electrical, or mechanical features of the electrodes. For example, electrochemical performance can be improved by addition of nickel, nickel hydroxide, nickel oxyhydroxide, or nickel oxide containing cathode material that can incorporate or be coated with small amounts of cobalt oxide, strontium hydroxide (Sr(OH)2), barium oxide (BaO), calcium hydroxide (Ca(OH)2), Fe3O4, calcium fluoride (CaF2), or yttrium oxide (Y2O3) to improve battery cell performance. As another example, electrode can includes an oxide such as bismuth oxide, indium oxide, and/or aluminum oxide. Bismuth oxide and indium oxide may interact with zinc and reduce gassing at the electrode. Bismuth oxide may be provided in a concentration of between about 1 and 10% by weight of a dry negative electrode formulation. Indium oxide may be present in a concentration of between about 0.05 and 1% by weight of a dry negative electrode formulation. Aluminum oxide may be provided in a concentration of between about 1 and 5% by weight of a dry negative electrode formulation.

In certain embodiments, one or more additives may be included to improve corrosion resistance of the zinc electrode material. Specific examples of anions that may be included to reduce the solubility of zinc in the electrolyte include phosphate, fluoride, borate, zincate, silicate, or stearate. Generally, these anions may be present in an electrode in concentrations of up to about 10% by weight of a dry electrode formulation.

Additives that improve electrical characteristics such as conductivity can also be added. For example, a range of carbonaceous materials can be used as electrode additives, including powdery or fibrous carbons such as graphite, coke, ketjen black, and acetylene black. Carbonaceous nanomaterials can also be used such as single or multiwalled carbon nanotubes, carbon nanofibers, multi-layered carbon nanoparticles, carbon nanowhiskers, or carbon nanorods.

Additives may be provided as chemically homogeneous components into a mixture or solution, co-precipitated, or coated onto particles

Mechanical properties can be improved in one embodiment by addition of binding agents to provide increased electrode mechanical strength, and flexure or crack reduction for the electrode. Binding agents may include, for example, polymeric materials such as polytetrafluoroethylene (PTFE), polyethylene (PE), polypropylene (PP), polyisobutylene (PIB), polyvinyl alcohol (PVA), polyacrylic acid, polyvinyl acetate, carboxy methyl cellulose (CMC), styrene butadiene rubber (SBR), polyethylene oxide (PEO) polybutylene terephthalate (PBT) or polyamides, polyvinylidene fluoride (PVDF), silicone-based elastomers such as polydimethyl siloxane (PDMS) or rubber materials such as natural rubber (NR), ethylene propylene rubber (EPM) or ethylene propylene diene

Ion Exchange Material

The ion exchange material is generally selective for the transport of either cations or anions. An anion selective ion exchange material can be used alone, a cation selective ion exchange material can be used alone, or they can be used in combination with each other. In one embodiment the ion exchange material can be an organic or polymeric material having attached strongly acidic groups, such as sulfonic acid including, sodium polystyrene sulfonate, or polyAMPS. Alternatively, the ion exchange material can be an organic or polymeric material having attached strongly basic groups, such as quaternary amino groups including trimethylammonium groups (e.g. polyAPTAC). In another embodiment, the ion exchange material can be an organic or polymeric material having attached weakly acidic groups, including carboxylic acid groups. Alternatively, the ion exchange material can be an organic or polymeric material having attached weakly basic groups, typically featuring primary, secondary, and/or tertiary amino groups (e.g. polyethylene amine).

The ion exchange can be provided to interact with electrode material as a fully or partially embedding polymer, a particle mixture, a membrane or film, particulates or beads, or a coating. The anode alone, the cathode alone, or both the anode or cathode can be configured to interact with an ion exchange material, which can be the same or different material for the respective electrodes.

### Electrolyte

An electrolyte is used to maintain high ionic conductivity between electrodes. Electrolytes can be aqueous based, solvent based, solid polymer, or an ionic liquid. In some embodiments, electrolytes can be semi-solid or gelatinized. Gelatinizing agents can include polymers that absorb the liquid of the electrolyte solution and swell. Such polymers can include polyethylene oxide, polyvinyl alcohol, and polyacrylamide.

In another embodiment the electrolyte can be a solid state electrolyte. In another embodiment electrolyte can be formed as a solid material with absorbed water. For example, KOH exposed to humid air.

In another embodiment electrolytes can be formed from ion exchange material such as explained above under “Ion exchange material” section.

In one embodiment aqueous alkaline electrolytes can be used. Alkaline electrolytes can include alkalis such as potassium hydroxide, sodium hydroxide, lithium hydroxide, calcium hydroxide or inorganic salts such as zinc bromide.

Separator

A separator may be replaced with (or used in conjunction with) an ion exchange membrane or film. A conventional porous polymer separator or ion exchange separator may be provided as a polymer membrane or film. Typically, a separator is disposed between the anode and the cathode and acts to prevent the anode and the cathode from having internal electrical shorts. In addition, the separator can also act to retain the electrolyte, particularly for battery systems that use different cathode and anode electrolyte solutions. The separator is generally required to have a porous structure or a structure having a number of perforations capable of allowing ions to pass while being chemically stable with respect to the electrolyte solution. In some embodiments, one or more separators can be formed by coating electrodes or particles that collectively form an electrode. The separator can be formed from a nonwoven fabric or a membrane having a micropore structure made of glass, polypropylene, polyethylene, resin, or polyamide. Alternatively, the separator may be constituted by a metal oxide film or a resin film combined with a metal oxide respectively having a plurality of perforations.

Processing

In one embodiment, a dry mixing process can be performed in which various anode and cathode materials, as well as additives and binders are mixed while dry. Optional processing steps such as heating, fusing, compressing, and melting ion exchange material can be performed before placing the mixture in a battery casing. In other embodiments, optional processing steps such as heating, fusing, compressing, and melting ion exchange material can be performed after placing the mixture in a battery casing. A liquid electrolyte can be added before sealing the battery casing.

According to other embodiments, a wet mixing process may instead be utilized. In a wet mixing process, one or more solvents are added at the beginning or during the mixing process, or, alternatively, one or more ingredients may be used in the form of a dispersion or suspension. The solvent(s) can be subsequently removed after the mixing process or later state in the production process.

In other embodiments, embodiment, the various individual components may be made using different methods. For example, some of the electrode may be produced using a dry mixing process, while portions of the electrode may be produced using a wet process. According to yet another embodiment, it is possible to combine both dry and wet processes for the different components. In still other embodiments, electrodes can be formed into monolithic blocks with three-dimensional channels or pores extending therethrough by sintering particles, drilling or subtractive manufacture, additive manufacture, chemical fusion, or use of additional adhesives, epoxies, or binders.

Battery and Cell Design

The battery cells of this invention can have any of a number of different shapes and sizes. For example, coin, prismatic, pouch or cylindrical cells can be used. Cylindrical cells of this invention may have the diameter and length of conventional AAA cells, AA cells, A cells, C, or D cells. Custom cell designs can be used in some applications. For example, prismatic cell designs can be used for portable or vehicular applications, as well as various larger format cells employed for various non-portable applications. A battery pack can be specifically designed for particular tools or applications. Battery packs can include one or more battery cells and appropriate casing, contacts, and conductive lines to permit reliable charge and discharge in an electric device. In some embodiments, electrodes can be sized to exactly fit within a casing of conventional AAA cells, AA cells, A cells, C, D cells, or other known or custom cell sizes. This can include manufacture and placement into a casing of a monolithic anode including at least one of zinc or zinc oxide and sized to exactly match the casing. This can include, for example, a bobbin style AA cell.

### Example 1

In embodiment, a zinc or zinc-including material can be formed into electrode (in this case an anode) having a plurality of three dimensional channels that form a sponge-like structure. Suitable manufacturing techniques are described in U.S. Pat. No. 9,802,254 to Rolison et al., with assignee The United States of America, as represented by the Secretary of the Navy and the disclosure of which is herein specifically incorporated by reference. In one embodiment, a zinc sponge-like structure capable of acting as an electrode can be formed by forming an emulsion having a zinc powder and a liquid phase; drying the emulsion to form a sponge; sintering the sponge in an inert atmosphere to form a sintered sponge; heating the sintered sponge in an oxidizing atmosphere to form an oxidized sponge having zinc oxide on the surface of the oxidized sponge; and heating the oxidized sponge in an inert atmosphere at above the melting point of the zinc.

In some embodiments, the zinc sponge-like structure contains two bicontinuous interpenetrating networks. One is solid and comprises zinc and the other is void space. Providing a porous zinc structure that may be in the form commonly referred to as a sponge. The zinc network may contain zinc on both the surfaces and the interior of the network. That is, it is not zinc coated onto a non-zinc porous substrate, and it may be pure or nearly pure zinc throughout. The zinc network may also comprise zinc oxide and/or zinc oxyhydroxides that form on the surface when the electrode is discharged in a cell. The zinc network is a fused, monolithic structure in three dimensions. Into this zinc sponge-like structure an electrolyte containing an ion exchange material can be introduced. Alternatively or in addition, ion exchange materials can include polymers can be used to define an interface with the zinc sponge-like structure.

In the foregoing description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The foregoing detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the FIGURES provided herewith are for explanation purposes to persons ordinarily skilled in the art and that the drawings are not necessarily drawn to scale.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims. It is also understood that other embodiments of this invention may be practiced in the absence of an element/step not specifically disclosed herein.

1. A rechargeable battery cell, comprising
an electrode having a plurality of three dimensional channels defined therethrough, with at least 90% of three dimensional channels sized to have pores between 50 nanometers to 400 microns; and
an ion exchange material arranged to define an interface with at least a portion of the electrode.

2. The rechargeable battery cell of claim 1, wherein the electrode further comprises a zinc (Zn) containing anode.

3. The rechargeable battery cell of claim 1, wherein the electrode is a cathode including at least one of nickel hydroxide (Ni(OH)₂), nickel oxyhydroxide (NiOOH), manganese dioxide (MnO₂), copper oxide, and bismuth oxide.

4. The rechargeable battery cell of claim 1, wherein the electrode has a monolithic structure.

5. The rechargeable battery cell of claim 1, wherein the electrode has a pore volume of greater than 50%.

6. The rechargeable battery cell of claim 1, wherein the three dimensional channels comprise branching sponge-like pore structures.

7. The rechargeable battery cell of claim 1, wherein the ion exchange material further comprises an anion exchange material.

8. The rechargeable battery cell of claim 1, wherein the ion exchange material further comprises a polymeric material.

9. The rechargeable battery cell of claim 1, wherein the ion exchange material further comprises a polymeric material having attached positively charged functional groups.

10. The rechargeable battery cell of claim 1, further comprising a liquid alkaline electrolyte.

11. The rechargeable battery cell of claim 1, further comprising an electrolyte having at least some incorporated ion exchange material.

12. The rechargeable battery cell of claim 1, further comprising an electrolyte which is liquid, solid or gel.

13. The rechargeable battery cell of claim 1, further comprising an electrolyte which is a hygroscopic solid material with absorbed water selected from the list comprising KOH, NaOH, LiOH or any combination thereof.

14. The rechargeable battery cell of claim 1, further comprising a collector at least partially embedded in the electrode.

15. The rechargeable battery cell of claim 1, further comprising a collector arranged to contact the electrode and formed from at least one of Sn, Cu, Fe, Stainless Steel, Ni, and Co.

16. A method of manufacturing a rechargeable battery cell, comprising
fusing a plurality of particles into a monolithic electrode having a plurality of three dimensional channels defined therethrough, with at least 90% of three dimensional channels sized to have pores between 50 nanometers to 400 microns; and
contacting the monolithic electrode with an ion exchange material.

17. The method of manufacturing a rechargeable battery cell of claim 16, wherein contacting the monolithic electrode with an ion exchange material further comprises at least one of melting, softening, depositing from a melt, laminating, and pressure application.

18. The method of manufacturing a rechargeable battery cell of claim 16, further comprising the step of contacting the monolithic electrode with a liquid electrolyte that can pulled by capillary force into the three dimensional channels defined therethrough.

19. The method of manufacturing a rechargeable battery cell of claim 16, further comprising the step of placement into a casing of a monolithic anode including zinc (Zn), with the monolithic anode sized to exactly match the casing.

20. The method of manufacturing a rechargeable battery cell of claim 16, further comprising the step of assembling the monolithic electrode with a liquid phase polymer membrane solution pulled by capillary force into three dimensional channels defined therethrough;
and drying the deposited polymer layer to form an ion exchange membrane coating of monolithic electrode.

21. The method of manufacturing a rechargeable battery cell of claim 16, further comprising embedding at least one of a metallic conductive mesh, wire and foil inside monolithic electrode before high temperature fusing.
